(19) United States
(12) Patent Application Publication
(10) Pub. No.: US 2014/0232362 A1
(43) Pub. Date: Aug. 21, 2014

(54) METHOD AND APPARATUS FOR IMPROVING DEVICE RELIABILITY USING ESTIMATED CURRENT IN A DYNAMIC PROGRAMMABLE SWITCHER DRIVER

(71) Applicant: QUALCOMM INCORPORATED, San Diego, CA (US)

(72) Inventors: Hanil Lee, San Diego, CA (US); Vijayakumar Dhanasekaran, San Diego, CA (US)

(73) Assignee: QUALCOMM INCORPORATED, San Diego, CA (US)

(21) Appl. No.: 13/773,384

(22) Filed: Feb. 21, 2013

(51) Int. Cl. H02M 3/155

(52) U.S. Cl. CPC H02M 3/155
USPC 323/271

(57) ABSTRACT

A method and apparatus for a dynamic programmable switcher driver using estimated current for device reliability is provided. The method adjusts a rate of closure of an electronic switch and begins when the load current of the Buck regulator is estimated. This estimated current flow is then compared with a predetermined threshold. If the estimated current flow is greater than the predetermined threshold then the rate of closure of the electronic switch is decreased. If the estimated current flow is less than the predetermined threshold then the rate of closure of the switch is increased. An apparatus for adjusting a rate of closure of an electronic switch is also provided. The apparatus includes: an adjustable p-driver having an internal register value; an adjustable n-driver having an internal register value; a positive switch connected to the adjustable p-driver; and a negative switch connected to the adjustable n-driver.

### BACKGROUND

1. Field

The present disclosure relates generally to switcher drivers, and more particularly, to a dynamic programmable switcher driver using estimated current.

2. Background

Wireless communication systems are widely deployed to provide various types of communication content such as voice, data, and so on. These systems may be multiple-access systems capable of supporting communications with multiple users by sharing the available system resources (e.g., bandwidth and transmit power). Examples of such multiple-access systems include code division multiple access (CDMA) systems, time division multiple access (TDMA) systems, frequency division multiple access (FDMA), 3GPP Long Term Evolution (LTE) systems, and orthogonal frequency division multiple access (OFDMA) systems, and Universal Mobile Telecommunications (UMTS) systems.

A key component of any wireless device is the processor. The processor requires varying amounts of current and voltage in order to perform tasks, execute applications, transfer data, and other functions. Power may be supplied through various power supplies or through setting different power levels in a single power supply. Often switching requires the use of transistors. The switching may result in ground bounce associated with transistor switching, where the gate voltage can appear to be less than the local ground potential, causing the unstable operation of a logic gate.

Ground bounce is usually seen on high density very large scale integrated circuit (VLSI) where inadequate provisions are taken to supply a logic gate with a sufficiently low resistance connection (or sufficiently high capacitance) to ground. In this situation, when the gate is turned on, enough current flows through the emitter-collector circuit that the silicon in the immediate vicinity of the emitter is pulled high, possibly by several volts, thus raising the local ground, as perceived by the transistor, to a value significantly above the true ground. Relative to this local ground, the base voltage of the transistor may go negative, shutting off the transistor. As the excess local charge dissipates, the transistor turns back on, possible causing a repeat of the phenomenon. This may occur up to a half-dozen “bounces.”

Ground bounce is a leading cause of “hung” or metastable gates in circuit designs. This occurs because the ground bounce puts the input of a flip flop effectively at a voltage level that is neither one nor zero at clock time, or causes untoward effects in the clock itself.

When the switcher in a cell phone or other device is switching on and off a voltage glitch occurs because of L*di/dt, where L is the series inductance including a parasitic routing inductance between the switcher and the AC ground, and i is the current through the switcher. As the series inductance and/or the switcher current increases, the voltage glitch increases. This voltage glitch may lead to device reliability issues which occur when the output inductor is affected by a sudden rise in voltage.

In a buck regulator excessive undershoot or overshoot on the internal voltage and ground nodes that provide input to the positive switch. A similar situation may also arise with respect to the negative switch. Such excessive overshoot or undershoot occurs when a fast switching event occurs (Lvdd*di/dt and Lgnd*di/dt). These overshoots or undershoots cause device stress, and may lead to a less reliable device.

There is a need in the art for a solution to the problems of device stress and reliability risks when a switcher is operating at high current on and off conditions. More specifically, there is a need in the art for a dynamic programmable drive utilizing sensing an estimated load current.

### SUMMARY

Embodiments disclosed herein provide a dynamic programmable switcher driver using estimated current for device reliability. The method adjusts a rate of closure of an electronic switch. The method begins when the load current of the Buck regulator is estimated. This estimated current flow is then compared with a predetermined threshold. If that estimated current flow is greater than the predetermined threshold then the rate of closure of the electronic switch is decreased. If the estimated current flow is less than the predetermined threshold then the rate of closure of the switch is increased. Multiples threshold levels and rates of closure may also be used.

A further embodiment provides an apparatus for adjusting a rate of closure of an electronic switch. The apparatus includes: an adjustable p-driver having an internal register value; an adjustable n-driver having an internal register value; a positive switch connected to the adjustable p-driver; and a negative switch connected to the adjustable n-driver.

Yet a further embodiment provides an additional apparatus for adjusting a rate of closure of an electronic switch. The apparatus includes: a logic comparator; an exclusive OR gate; an AND gate connected to the exclusive OR gate; an inverter for enabling a pulse width modulation input to the AND gate; an inverter for dynamically selecting a positive driver, connected to the AND gate; and a switch connected to the AND gate.

A still further embodiment provides an apparatus for adjusting a rate of closure of an electronic switch. The apparatus includes: means for estimating the load current of the Buck regulator; means for comparing the current flow estimate with a predetermined threshold; means for slowing a rate of closure of a switch when the current flow estimate is greater than the predetermined threshold; and means for increasing the rate of closure of a switch when the current flow estimate is less than the predetermined threshold. This adaptive rate of closure of switch allows to avoid reliability issues at high load current while conserving the Buck regulator's efficiency at medium/light load current levels.

An additional embodiment provides a non-transitory computer-readable medium containing instructions for adjusting a rate of closure of an electronic switch, which, when executed, cause a processor to perform the steps of: estimating the load current of the Buck regulator; comparing the current flow estimate with a predetermined threshold; slowing a rate of closure of a switch when the current flow estimate is greater than the predetermined threshold; and increasing the rate of closure of a switch when the current flow estimate is less than the predetermined threshold.

### BRIEF DESCRIPTION OF THE DRAWINGS

FIG. 1 is a block diagram of a Class H amplifier in accordance with an embodiment.

FIG. 2 illustrates a circuit diagram showing the current loops through the positive and negative switches that give rise to the voltage glitch.

FIG. 3 illustrates creation of a voltage glitch when the positive switch is turned off.

FIG. 4 illustrates creation of a voltage glitch when the negative switch is turned off.

FIG. 5 depicts an apparatus for dynamically controlling driver strength, according to an embodiment.

FIG. 6 shows an apparatus for dynamically controlling driver strength according to an embodiment.

FIG. 7 illustrates a programmable driver according to an embodiment.

FIG. 8 is a flow diagram for a method of dynamically controlling driver strength using estimated current, according to an embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

Amplifiers used in cell phones and other mobile devices may operate with a push-pull type transistor. Such a transistor operates around a zero point and is symmetrical in its operation about this point. Often, a pair of transistors are used. One transistor has positive driving and the other transistor of the pair has negative driving. As an example, the positive transistor may use +5 volts as a driving voltage while the negative transistor may use −5 volts as a driving voltage. The voltage values are commonly known as “rails” as they are set at fixed values.

In operation, the transistors generate heat as a result of power dissipation. This heat is a by-product of operation and harms battery life, making it much shorter. It may also shorten device life.

One amplifier that may be selected for use in mobile devices is the Class H amplifier, which uses a switcher power supply for voltage generation. The Class H amplifier has reduced power dissipation, providing greater battery life and potentially greater reliability. Often a switching power supply is used in the Class H amplifier because of its high efficiency, potentially as high as 95 percent. This switching power supply varies the value of the two power supplies in relation to the amplified signal.

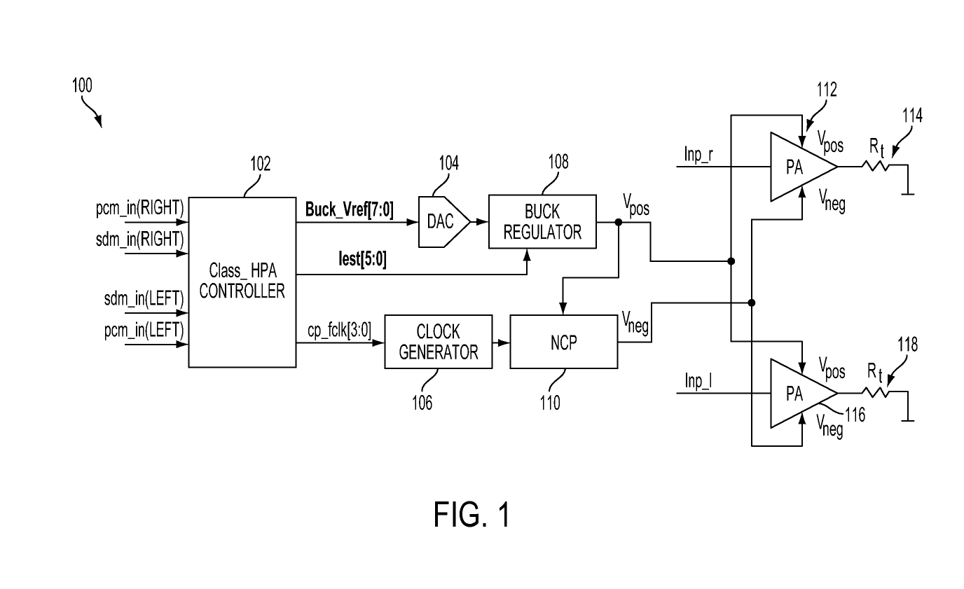

FIG. 1 shows a Class H amplifier with 256 power supply levels with low pass filter (LPF) tracking over a voltage range of +/−0.45V to +/−2.0V. The Class H amplifier assembly 100 includes a Class H power amplifier (PA) controller 102. This PA controller 102 is connected to a digital to analog converter (DAC) 104, to a buck regulator 108, and to a clock generator 106. The DAC 104 is also connected to the buck regulator 108. The clock generator 106 is connected to the negative charge pump 110, which also receives input from the positive output of the buck regulator 108. At this point the buck regulator 108 has produced a positive voltage Vpos, and the negative charge pump 110 has produced a negative voltage. The positive voltage is input to power amplifier (PA) 112. The negative voltage is input to a second PA 116. PA 112 also receives a negative voltage input and PA 116 also receives a positive voltage input. PA 112 is also connected to resistor 114. PA 116 is connected to resistor 118.

The load current of buck regulator 108 is predictable due to the known value of the PA 112 output signal and standard load resistance. In the Class H amplifier one transistor runs off the positive voltage rail and one transistor runs off the negative voltage rail. When the signal is above the voltage the positive transistor is driven and the negative transistor is turned off When the signal is below the voltage the negative transistor is driven and the positive transistor is turned off. The PA controller 102 provides buck regulator 108 with a voltage reference for positive voltage generation and a current estimate for efficient operation. As shown in FIG. 1, the Class H amplifier operates symmetrically about the zero point.

When the switcher is switching on and off a voltage glitch occurs because of L*di/dt, where L is the series inductance, including a parasitic routing inductance between the switcher and AC ground, and i is the current through the switcher. As the series inductance and/or the switcher current increases the voltage glitch increases, which may lead to device reliability issues, and even device failure.

The load current of buck regulator 108 is predictable because of the known value of the PA output signals and standard load resistance. Digital PA controller 102 provides buck regulator 108 with a voltage reference for positive voltage generation and a current estimate for efficient operation.

In buck regulator 108 an excessive undershoot over overshoot on the internal voltage and ground nodes may arise when a fast switching event occurs (Lvdd*di/dt and Lgn*di/dt). These overshoots or undershoots are the source of device stress.

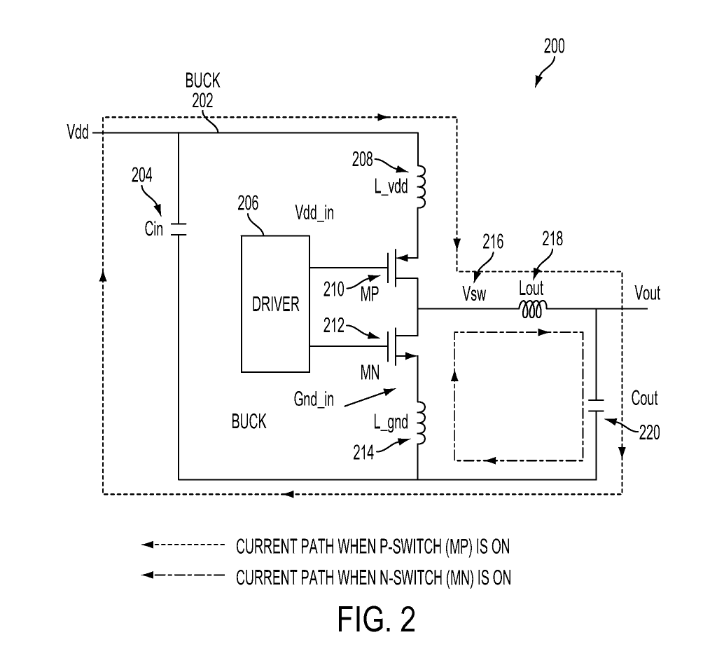

FIG. 2 shows the how the voltage glitch arises due to L*di/dt. The complete circuit path 200, includes two current loops. Loop 1 reflects the configuration when the positive switch (P-switch) is on. In this situation the current loop begins with the input voltage Vdd input to the buck 202. Vdd flows to input capacitor 204 and also to input inductor 208. Input inductor 208 is connected to the positive switch (MP) 210. The current flows out of MP 210 through output inductor 218 and then to output capacitor 220. The output capacitor may be replaced by a load. From the output capacitor 220 the current flows to the input capacitor 204. This path may be described as: Vdd through Pswitch->Vsw->Vout->Cout (and/or load)->gnd_ext->Cin->Vdd.

A second current loop arises when the negative switch (MN) 212 is on. A ground flows through MN 212 and thence to output inductor 218, then to output capacitor 220 and to the ground inductor 214. This path may be summarized by: gnd through MN 212>Vsw->Vout->Cout (and/or load)->gnd. Parasitic inductances are found on both the Vdd input (L_vdd) and ground (Gnd) inputs.

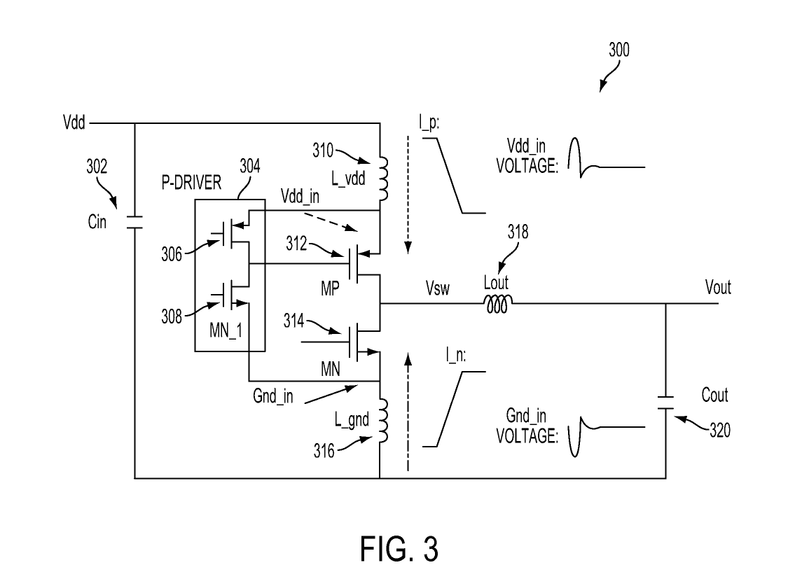

FIG. 3 depicts a first cause of the voltage glitch described above. The first cause is the P-switch turning off When the positive switch turns off its current (I_p) ramps down, causing an overshoot of L_vdd*di/dt on the input voltage node. At the same time, the negative switch picks up the inductor current through the body diode, and the current in the negative switch ramps up, causing an undershoot of L_gnd*di/dt on the input ground node. This event may damage the positive switch due to excessive Vds (drain to source voltage).

The assembly 300 includes input capacitor 302 and P-driver 304. P-driver 304 includes switch 306 and negative switch MN_{—}1 308. The input voltage Vdd is input to input inductor 310, which in turn provides input to switch 306 of P-driver 304. P-driver 305 provides input to switch MP 312. The output of MN_{—}1 308 is the input ground Gnd_in which is provided to ground inductor 316. V_sw is output from MP312 and MN 314 and is input to output inductor 318. The output voltage Vout is then provided to output capacitor 320, which is also connected to ground inductor 316 and input capacitor 302. The small graphical representations in FIG. 3 show the sudden spike in voltage caused by the voltage glitch.

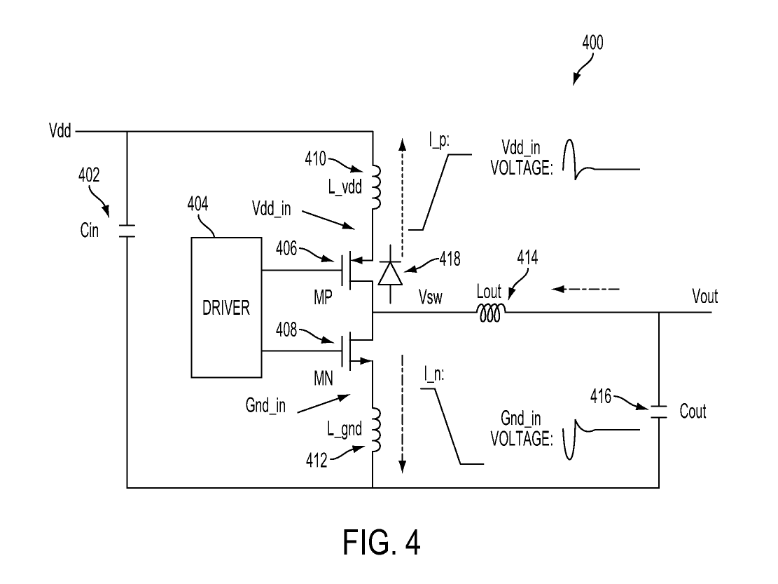

FIG. 4 illustrates a second cause of the voltage glitch, the negative switch turning off. The assembly 400 includes input capacitor 402 that is connected to Vdd and also to input inductor 410. The output of input inductor 410 is provided to the positive switch MP 406, which includes body diode 418. MP 406 provides input to driver 404. Driver 404 is also connected to the negative switch MN 408. The output from MN 408 is input to ground inductor 412. The output from inductor 412 is provided to the output capacitor 416 and from output capacitor 416 to output inductor 414.

When MN 408 turns off during reverse conduction, its' current I_n ramps down, causing an undershoot of L_gnd*di/dt on ground input node. At the same time, the inductor current works its' way through the body diode 418 of MP 406. Because of the current in the body diode 418 of MP 406 current I_p ramps up, causing an overshoot of L_Vdd*di/dt on Vdd input node. This may cause damage to the negative switch MN 408 (whose Vds=Vdd+L_vdd*di/dt+Vd+L_gnd*di/dt), where Vd is the voltage drop across body diode 418. This action may be more severe than that seen when the positive switch turns off, and consequently may be even more damaging. The larger the reverse current is, the higher Vds the negative switch 408 will see.

A solution to the problems described above it to periodically turn on and off the MP and MN switches. The method described herein takes the parasitic inductance into account because it is the parasitic inductance that may cause V_{dd}_{_{—}}ᵢₙ to become too high for the device to tolerate. This excessive voltage may lead to failure of the devices connected to V_{dd}_{_{—}}ᵢₙ. While the MP switch may be turned off, the voltage passing through the switch does not drop to zero due to the parasitic inductance. The method described in detail below reduces the voltage peak and avoids damaging or destroying the positive switch.

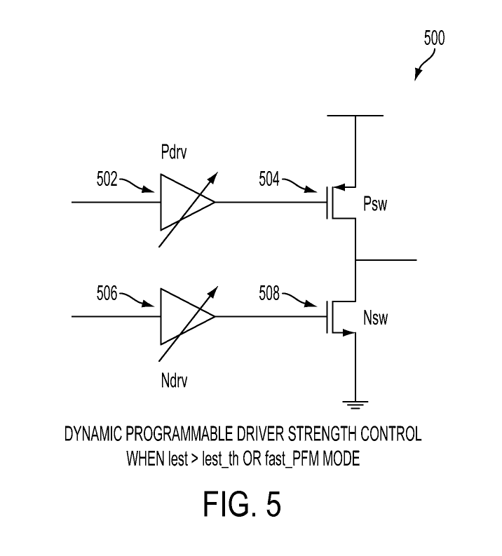

FIG. 5 depicts a dynamic programmable driver that provides driver strength control when Lₑₛₜ>Lₑₛₜ_{_{—}}ₜₕ or fast_pulse frequency modulation (PFM) mode. The apparatus provides for P-switch driver strength that may be reduced or changed from the internal register P driver value (man_pdrv<3:0>:0˜3) in order to adaptively slow the P-switch turn on or off time. It is this turn on and off time reduction that reduces the voltage glitch by the L*di/dt effect at V_{dd}_{_{—}}ᵢₙ and which also mitigates device stress on the P-switch.

The assembly 500 includes an adjustable P-driver 502 that is connected to the P-switch 504. P-switch 504 is a transistor switch of any suitable type for the application. In many cases, the P-switch may be a CMOS device. An adjustable N-driver 506 is similarly connected to N-switch 508. Output of N-switch 508 is connected to ground.

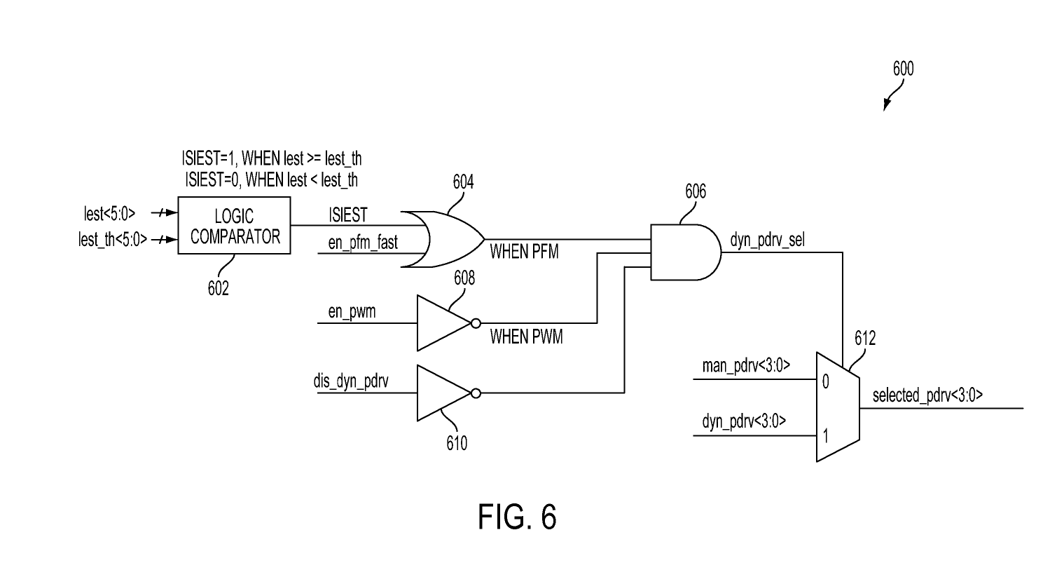

FIG. 6 illustrates the apparatus used to dynamically adjust P-driver strength. The assembly 600 includes logic comparator 602 which is connected to exclusive OR gate 604. Exclusive OR gate 604 provides an input to AND gate 606. Inverter 608 accepts pulse width modulated (PWM) enable related signal inputs and provides an input to AND gate 606 when PWM is used. A further inverter 610 provides dynamic P-driver input to AND gate 606. The output of AND gate 606 is provided to switch 612. Switch 612 has both 0 and 1 inputs, depending on the received logic state. The output of switch 612 provides the dynamic P-driver control.

Dynamic P-driver strength is selected when the Class H controller in the amplifier detects that Iₑₛₜ (Iₑₛₜ<5:0>) is larger than a predetermined threshold (Iₑₛₜ_{_{—}}ₜₕ<5:0>) or fast PFM mode (en_pfm_fast=high) in the PFM mode. FIG. 6 illustrates the dynamic P-driver strength embodiment. The threshold (Iₑₛₜ_{_{—}}ₜₕ<5:0>) is programmable within a desired range. One example of such a range is from 50 mA/100 mA (default)/200 mA/400 mA by a 2-bit buck internal register, which is suitable for mobile device application. The dynamic P-driver set value (dyn_pdrv<3:0>) is programmable from 0/1/2(default)/3 by a 2-bit register, which is also suitable for mobile device application. One of skill in the art would recognize that other ranges may be used without departing from the spirit and scope of this description. Both P-switch driver strength (driver_psw<3:0>) and N-switch driver strength (driver_nsw<3:0>) are programmable from 0/1/2/3/4/5/6/7 (default)/8/9/10/11/12/13/14/15 by 4-bit registers respectively. Other driver strength ranges may also be selected, depending on the application.

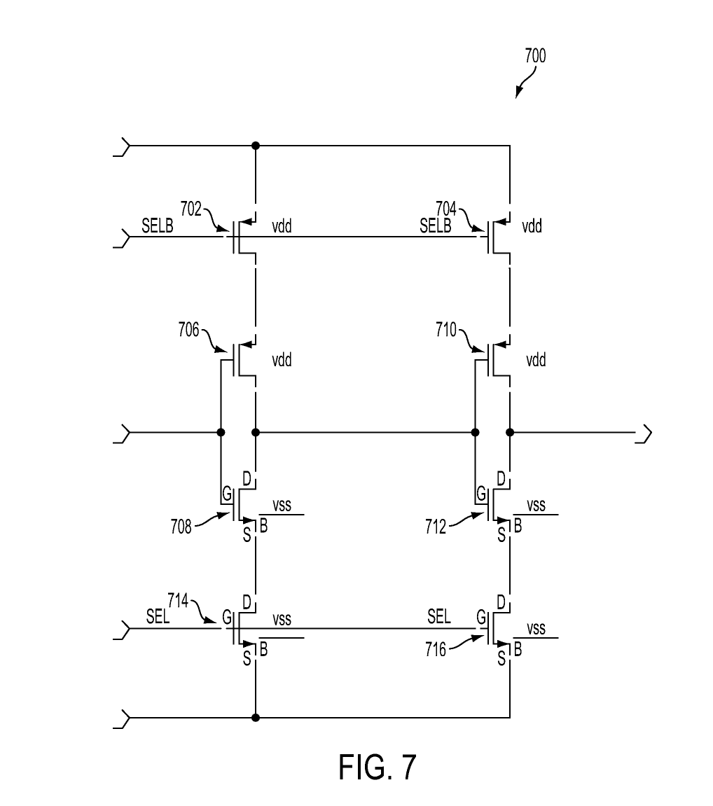

FIG. 7 shows a further embodiment of a dynamic programmable driver with a switched cascaded driver topology. Dynamic P-driver strength is selected when a Class H controller estimates Iₑₛₜ<5:0> to be larger than a predetermined threshold (Iₑₛₜ_{_{—}}ₜₕ<5:0>) of fast PFM mode (en_PFM_fast=high) in the PFM mode. As an example of values that may be selected for a cascaded driver topology, the sizes of the programmable drivers are 16-multiple of cbuf12p0 size for the P-switch driver and cbuf2p5 for the N-switch driver with each 4-bit register programmable.

The embodiment shown in FIG. 7, 700 includes transistor switches 702, 704, 706, 708, 710, 712, 714, and 716 interconnected as shown. The programmable driver is designed to allow for both the P-switch and the N-switch drivers to be programmable to mitigate reliability issues and to provide margin for future designs that may have larger parasitic inductance values than expected.

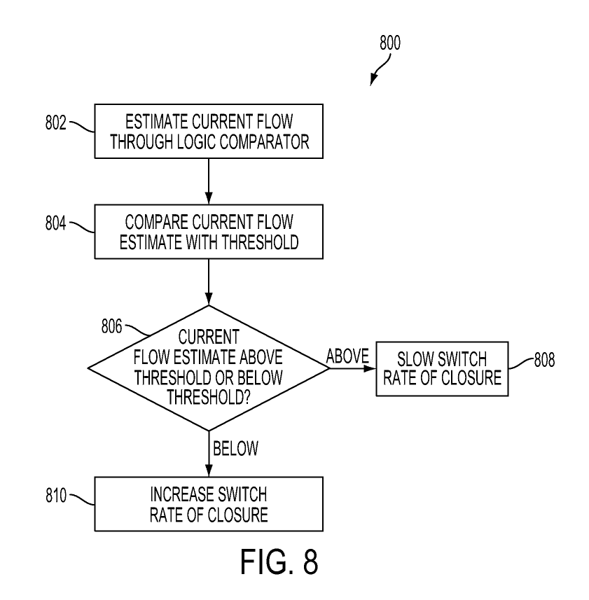

FIG. 8 is a flowchart of a method for adjusting a rate of closure of an electronic switch in accordance with the embodiments discussed above. The method 800 begins when the load current of the Buck regulator is estimated at step 802. In step 804 the current flow estimate is compared with a predetermined threshold. The predetermined threshold is based on the application using the device and the levels of current and voltage expected. In step 806 it is determined if the current flow estimate is above or below the predetermined threshold. If the current flow estimate is above the predetermined threshold, the switch rate of closure is slowed, in step 808. If the current flow estimate is below the predetermined threshold, the switch rate of closure is increased in step 810. The method ends when the switch rate of closure is adjusted.

The methods and apparatus described above allow for saving silicon devices that would otherwise be unusable, thus increase device yields. In addition, the method and apparatus allow the use of silicon devices with higher parasitic inductance.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for adjusting a rate of closure of an electronic switch, comprising:
estimating the load current of the Buck regulator;
comparing the current flow estimate with a predetermined threshold;
slowing a rate of closure of a switch when the current flow estimate is greater than the predetermined threshold; and
increasing the rate of closure of a switch when the current flow estimate is less than the predetermined threshold.

2. The method of claim 1 wherein the predetermined threshold is based on an internal register driver value of the switch.

3. The method of claim 1 wherein the switch is a positive switch.

4. The method of claim 1 wherein the switch is a negative switch.

5. An apparatus for adjusting a rate of closure of an electronic switch, comprising:
an adjustable p-driver having an internal register value;
an adjustable n-driver having an internal register value;
a positive switch connected to the adjustable p-driver; and
a negative switch connected to the adjustable n-driver.

6. The apparatus of claim 2, where the positive switch is a transistor.

7. The apparatus of claim 2, where the negative switch is a transistor.

8. The apparatus of claim 2, where the positive switch is a transistor and the negative switch is a transistor.

9. The apparatus of claim 5, where both the positive switch and the negative switch are CMOS transistors.

10. An apparatus for adjusting a rate of closure of an electronic switch, comprising:
a logic comparator;
an exclusive OR gate;
an AND gate connected to the exclusive OR gate;
an inverter for enabling a pulse width modulation connector to the AND gate;
an inverter for dynamically selecting a positive driver, input to the AND gate; and
a switch connected to the AND gate.

11. The apparatus of claim 7, wherein the switch is a positive switch.

12. The apparatus of claim 7, wherein the switch is a negative switch.

13. An apparatus for adjusting a rate of closure of an electronic switch, comprising:
means for estimating the load current of the Buck regulator;
means for comparing the current flow estimate with a predetermined threshold;
means for slowing a rate of closure of a switch when the current flow estimate is greater than the predetermined threshold; and
means for increasing the rate of closure of a switch when the current flow estimate is less than the predetermined threshold.

14. The apparatus of claim 13, wherein the means for comparing the current flow estimate with a predetermined threshold uses an internal register driver value of the switch.

15. A non-transitory computer-readable medium containing instructions for adjusting a rate of closure of an electronic switch, which when executed cause a processor to perform the steps of:
estimating a current flow through a logic comparator;
comparing the current flow estimate with a predetermined threshold;
slowing a rate of closure of a switch when the current flow estimate is greater than the predetermined threshold; and
increasing the rate of closure of a switch when the current flow estimate is less than the predetermined threshold.

16. The non-transitory computer-readable medium of claim 15, wherein the predetermined threshold is based on an internal register driver value of the switch.
